(19) United States
(12) Patent Application Publication
(10) Pub. No.: US 2005/0268281 A1
(43) Pub. Date: Dec. 1, 2005

(54) Portable annotated merge model and methods of using the same

(76) Inventors: Kim Letkeman, Nepean (CA); Geoffrey M. Clemm, Concord, MA (US)

Correspondence Address: GUERIN & RODRIGUEZ, LLP, 5 MOUNT ROYAL AVENUE, MOUNT ROYAL OFFICE PARK, MARLBOROUGH, MA, 01752, US

(21) Appl. No.: 10/852,791

(22) Filed: May 25, 2004

(51) Int. Cl. G06F 9/44

(52) U.S. Cl. 717/120

(57) ABSTRACT

A portable annotated merge model and methods of generating and using the same are provided. The portable annotated merge model can be a copy of a baseline file having annotation associated with items of the baseline file. The annotation can be deltas and/or conflicts. The portable annotated merge model is transferable and suspendable to facilitate collaboration among multiple reviewers of the merge model.

### FIELD OF THE INVENTION

The invention relates to software development systems. More specifically, the invention relates to merging changes to a baseline file made by multiple editors of the baseline file.

### BACKGROUND OF THE INVENTION

Structured information such as a Unified Modeling Language (UML) model is often stored in the Extensible Markup Language (XML), which provides a simple method for storing machine-readable hierarchical data. A UML model is highly structured with overlays for a class hierarchy, a containment hierarchy (parent-child) and a mesh network of references implemented using internal and external (cross-model) references.

An instance of a UML model can grow to encompass a large number of components or subsystems. The chance that a number of developers and/or modelers will make simultaneous changes increases dramatically as the file grows in size. For example, with a large UML model, one person could be working with embedded diagrams while another could be restructuring the package hierarchy of a system. The potential for conflicting changes is high, because classes are moving and diagrams (that likely reference one or more classes) are also changing. Parallel development is common in large development teams. Each time two contributors work simultaneously on the same file, a merge of the changes is performed when the second person checks the file back into a source control system. An example of a source control system is CLEARCASE sold by Rational Software of Armonk, N.Y.

The complexity of structured data forces the user performing the merge (i.e., the merger) to examine conflicting changes (deltas) and to select from the alternatives to resolve all changes before proceeding to commit the changes to the file. Often the merger does not have sufficient expertise to resolve conflicts within specific diagrams or any other specialized section of the file. Current merge techniques do not allow for the suspension of the merge session. That is, once a merge session is started it has to be completed before access to the file is granted. This requires that the merger make choices to resolve conflicts that the merger may not be qualified to make.

### SUMMARY OF THE INVENTION

The following presents a simplified summary of the invention in order to provide a basic understanding of some aspects of the invention. This summary is not an extensive overview of the invention. It is not intended to identify key or critical elements of the invention or delineate the scope of the invention. The sole purpose of the summary is to present some concepts of the invention in a simplified form as a prelude to the more detailed description presented below.

In one aspect, the invention relates to a computer readable medium that generates a portable annotated data structure, file, or similar means for merging changes to a baseline file. The data structure includes a baseline data structure and at least one delta associated with a portion of the baseline data structure.

In another aspect, the invention relates to a method for merging changes made to a baseline structured data file. The method includes beginning a first merge session by accessing an annotated structured data file, reviewing at least one annotation within the annotated data file, saving the annotated data file to create an incomplete merge file and closing the first merge session upon completion of the first merge session.

### BRIEF DESCRIPTION OF THE DRAWINGS

The above and further advantages of this invention may be better understood by referring to the following description in conjunction with the accompanying drawings, in which like numerals indicate like structural elements and features in various figures. The drawings are not necessarily to scale, emphasis instead being placed upon illustrating the principles of the invention.

FIG. 1 is a block diagram of a computer system in which principles of the invention may be practiced.

FIG. 2 is a flow chart of an embodiment of the invention.

FIG. 3 is a block diagram of an embodiment of a system for generating an annotated file according to the principles of the invention.

FIG. 4 is a flow chart depicting an embodiment of the steps performed by the system of FIG. 3.

FIG. 5 is an exemplary embodiment of a data structure schema for a delta constructed according to the principles of the invention.

### DETAILED DESCRIPTION

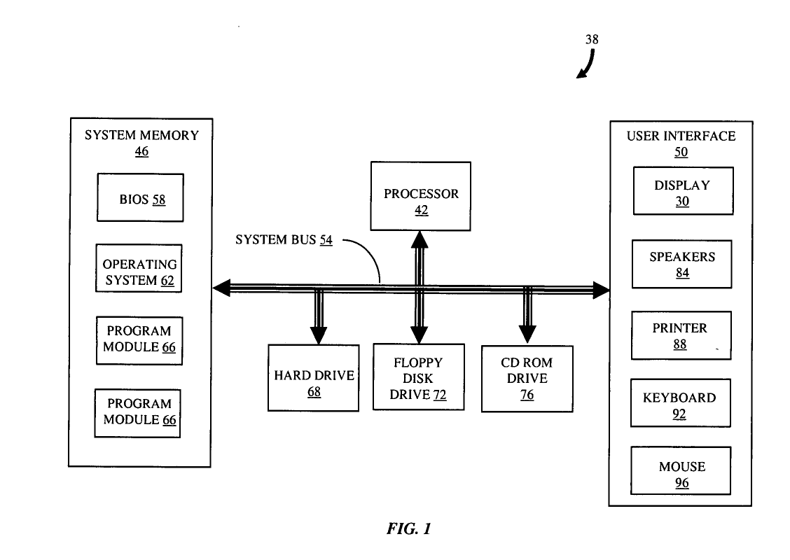

FIG. 1 is a functional block diagram of a conventional personal computer (PC) 38 which in the invention may be practice. The PC 38 includes a processor 42, a system memory 46 and a user interface 50 coupled to each other over a system bus 54. The system memory 46 includes read-only memory (ROM) and RAM. Basic routines used to transfer information between the components of the PC 38 at certain times, such as during startup, are included in a basic input/output system (BIOS) 58 in ROM. The BIOS 58 provides an interface between the PC's operating system 62 (e.g., Windows, Mac OS, Linux) and the specific hardware configuration of the PC 38, including the processor 42 and the system memory 46. The system memory 46 also includes various program modules 66 such as word processing applications, presentation applications and spreadsheet applications.

The PC 38 generally includes other components, for example one or more hard disk drives 68, magnetic disk drives 72, optical disk drives 76 and the like. The drives 68, 72, 76 enable read from and write to operations for various forms of computer-readable media and allow for non-volatile storage of computer readable instructions, data structures and other data. The user interface 50 includes a display 30 and other peripheral output devices, such as speakers 84 and a printer 88, connected through various interface modules (not shown) to the system bus 54. Commands and information are entered into the PC 38 through input devices such as a keyboard 92 and a mouse 96.

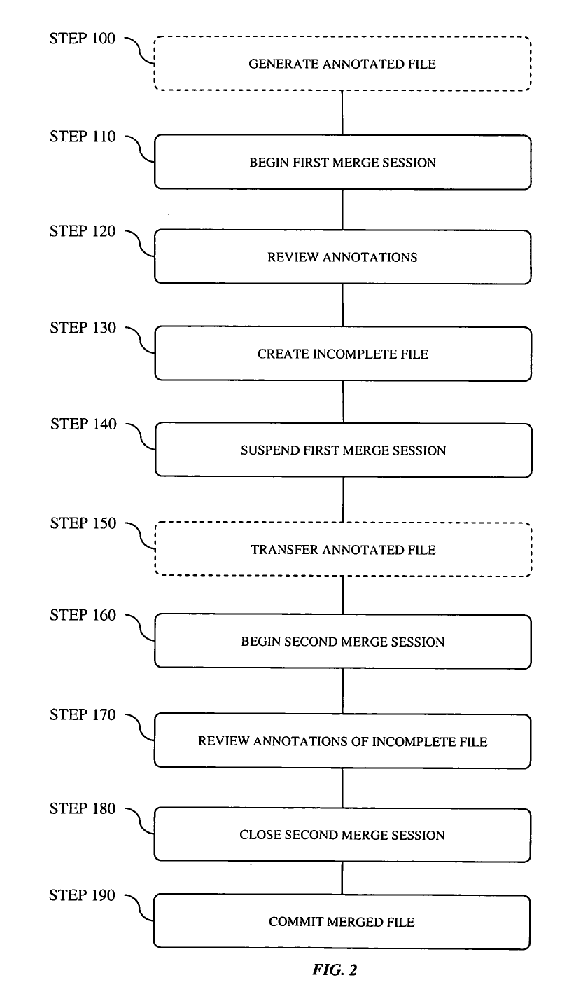

FIG. 2 depicts a method of merging changes made to a baseline file according to one embodiment of the invention. Prior to merging changes created by multiple editors of a baseline file, an annotated file is generated (STEP 100). The term file, as used herein, includes files, models, or any other representation of computer instructions known to those of ordinary skill in the art. The term editor, as used herein, includes programmers, modelers, and revisers, as well as any other term, machine, or person known to those of ordinary skill in the art which indicates the ability to make changes to a file. A first merge session begins by accessing the annotated file (STEP 110).

A software editing tool, for example ECLIPSE, which is distributed at http:/Hwww.eclipse.org, includes a “mergeware” component. As used herein, the term mergeware includes any device, method, or machine that can read and/or display the annotations within the annotated file to an operator of the merge session. The mergeware application can be an extension (e.g., plug-in module) of a standard editor or a separate application.

The mergeware application displays the annotated file to a user (i.e., a reviewer), who reviews the various annotations within the annotated file (STEP 120). The user makes changes to the annotated file in various ways. For example, the user resolves a conflict between two or more contributors to the annotated file. The user selects one of the conflicting changes. During the first merge session, the state of the annotated file is captured to create an incomplete merge file (STEP 130). The term incomplete merge file, as used herein, represents the annotated file after any change, attempt to change, or review of the annotated file occurs during the first merge session. For example, if the user reviews a conflict but can not decide which contributor change to accept, the review of the annotated file results in the creation of the incomplete merge file although no changes were actually made to the annotated file. In one embodiment, the incomplete merge file includes the annotated file, a first status table indicating changes applied to the annotated file, and a second status table indicating unapplied changes to the annotated file. After the user reviews the annotated file, the user suspends the first merge session (STEP 140). As used herein, suspending the first merge session includes any or all of the following: closing the session, pausing the session, postponing the session, deferring the session, delaying the session, halting the session, and interrupting the session.

Optionally, the user transfers the incomplete merge file after suspending the first merge session (STEP 150). Examples of transferring include, but are not limited to, emailing the incomplete merge file, posting the incomplete merge file to a shared workspace, checking the incomplete merge file into the source management system, or notifying another user to access the incomplete merge file without sending the incomplete merge file to the user. A second merge session begins by accessing the incomplete merge file (STEP 160). In one embodiment, the user that created the incomplete merge file resumes reviewing annotations of the incomplete merge file. In an alternate embodiment, another user can review the annotations of the incomplete merge file in response to the transmission step (STEP 170). The state of the incomplete merge file is captured during the second merge session as previously described above. After the user reviews the incomplete merge file, the user suspends the second merge session (STEP 180). A third merge session can be started if annotations of the incomplete merge file require further review. As one of ordinary skill in the art recognizes, the process of starting and suspending merge sessions can continue until the each annotation is satisfactorily addressed. After the annotations are addressed, the user commits the merged file (STEP 190). Committing, as used herein, refers to the process of saving the changes to the annotated file and returning the file to the source management system. The merged file is returned to the source management system and becomes a new baseline file for contributors to edit.

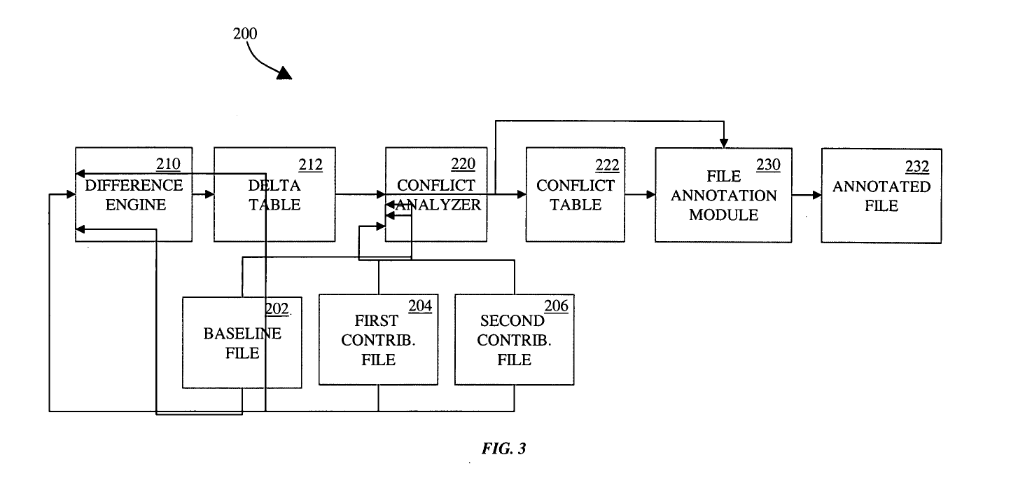

FIG. 3 depicts an embodiment of an annotated file generation system 200. The system 200 includes a difference engine module 210, a conflict analyzer module 220, and a file annotation module 230. The difference engine module 210 communicates with the conflict analyzer module 220 and the file annotation module 230. The conflict analyzer module 220 communicates with the difference engine module 210 and the file annotation module 230. In one embodiment, each of the modules 210, 220, and 230 are software based, although hardware can also be used.

As a general overview of the operation of the annotated file generation system 200, the difference engine module 210 receives a baseline file 202, a first contributor file 204, and a second contributor file 206 from the source management system. In one embodiment, the difference engine module 210 creates a table of deltas 212 (i.e., changes) after analyzing the baseline file 202 and contributor files 204,206. The conflict analyzer module 220 reviews the baseline file 202, the contributor files 204,206, and the results of the difference engine module 210 and determines if conflicting changes appear in the files. In one embodiment, the conflict analyzer module 220 stores the results in a conflicts table 222. The file annotation module 230 copies the baseline file 202 and incorporates the results of the difference engine module 210 and conflict analyzer module 220 as annotations to the baseline file 202 to create an annotated file 232.

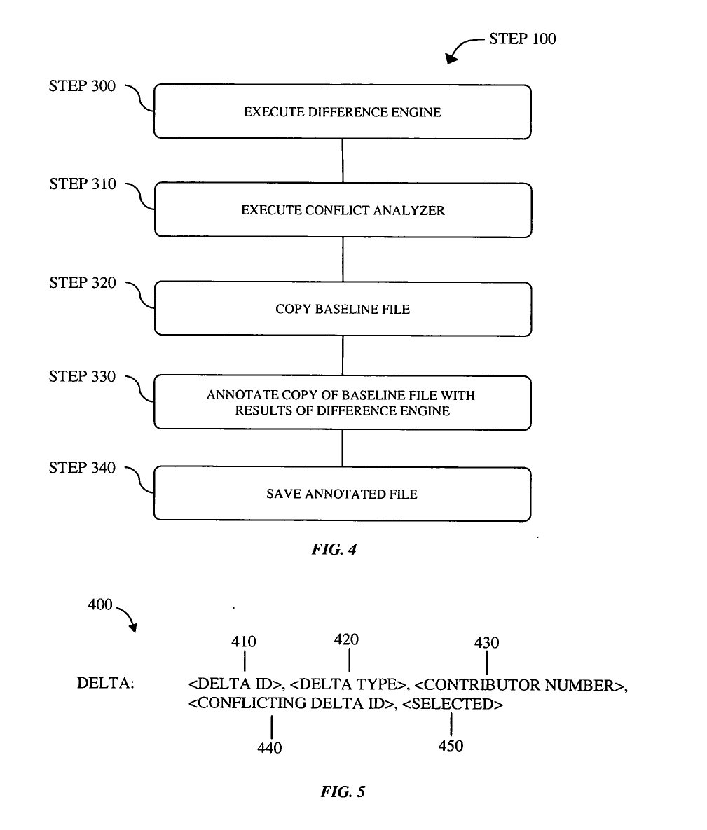

In more detail, FIG. 4 depicts one embodiment of a method of generating the annotated file 232 (STEP 100) performed by the system 200. The difference engine module 210 executes and analyzes a plurality of files and generates a set of deltas (STEP 300). For example, the difference engine module 210 compares the baseline file 202 to the first contributor file 204 and the second contributor file 206 and determines the changes, if any, each contributor made to the baseline file 202. To generate a more complete set of deltas, the baseline file 202 is compared to each of the contributor files 204,206 and then each of the contributor files 204,206 is compared to the baseline file 202. The difference engine module 210 also generates composite deltas, which are either stored in a composite delta table (not shown) or in the delta table 212. As used herein, a composite delta means multiple deltas that are related and applied together. For example, if delta D1 is accepted than delta D2 must also be accepted in order to maintain the validity of the file. The difference engine module 210 analyzes the delta table 212 and determines this relationship to generate a composite delta CD1.

In addition to the difference engine module 210 generating deltas, the conflict analyzer module 220 reviews each of the files (STEP 310). The conflict analyzer module 220 recognizes conflicting changes to the baseline file created by the different contributors. The conflict analyzer module 220 includes strategies for determining conflicts.

The conflict analyzer module 220 is language specific. For example, an Eclipse Model Framework (EMF) conflict analyzer module differs from a Java conflict analyzer. The user declares the language of the conflict analyzer module 220. A structural conflict is one example of a conflict generated by the conflict analyzer module 220. For instance, assume the baseline file includes independent packages P1 and P2. In the first contributor file, contributor one changes the'structure of the baseline file making P2 a child of P1. In the second contributor file, contributor two changes the structure of the baseline file making P1 a child of P2. These changes result in a conflict during the merge operation, because P2 cannot be a child of P1 and a parent of P1. The conflict analyzer module 220 recognizes this situation and generates an annotation that is included in the annotated file 232.

The file annotation module 230 copies the baseline file 202 used by the difference engine 210 (STEP 320). Using a copy of the original baseline file preserves the state of the baseline file 202 during the merge process and allows for the portability of the annotated file. The original baseline file 202 does not contain changes made by the contributors. Preserving the original baseline file 202 provides a point of return in the event of an error or failure during the merge process. The file annotation module 230 incorporates the annotations into the copy of the baseline file (STEP 330). In one embodiment, the file annotation module 230 copies the annotations from the respective contributor file. In another embodiment, the file annotation module 230 copies the annotations from the respective tables 212, 222 generated by the difference engine module 210 and conflict analyzer module 220. The annotations are incorporated into the file such that the annotations do not have a negative effect on the ability of the editor software to operate on the file. Said another way, the annotations are “invisible” to the editor software. In one embodiment, the annotations are inserted as comments in the copy of the baseline file. The copy of the baseline file with the incorporated annotations is saved as the annotated file (STEP 340).

FIG. 5 is an exemplary annotation format schema used for creating the annotated file 232. A delta 400 is stored in the XML format and includes a delta ID tag 410, a delta type tag 420, a contributor number tag 430, a conflicting delta ID tag 440, and a selection indication tag 450. The delta ID tag 410 is a unique identifier within the annotated file that references a specific delta within the annotated file. The delta type tag 420 indicates a “type” of delta. Examples of the delta type tag 420 include, but are not limited to, add, change, delete, move, and reorder. The contributor number tag 430 indicates which contributor file produced the delta. The conflicting delta tag 440 indicates which other delta the present delta conflicts with. The conflicting delta tag 440 is set to 0 to indicate that the delta is a non-conflicting delta. The selection identification tag 450 indicates whether or not the delta is chosen during the merge process. In one embodiment, if conflicting delta tag 440 is set to 0, then setting the selection indication tag 450 to 0 indicates the baseline file is selected, while setting the value to 1 indicates the delta replaces the baseline file. If the conflicting delta tag 440 is set to 1 to indicate there are conflicting deltas, then setting the selection indication tag 450 to 0 for the conflicting deltas indicates that none of the conflicting deltas is selected and the baseline file remains unchanged. In one embodiment, the method checks the conflicting deltas to confirm that their respective selection indication tags 450 are set to 0. In an alternate embodiment, the delta schema 400 includes additional tags such as a selection tag 460 (not shown) and a reverted tag 470 (not shown). Setting the selection tag equal to 1 indicates the conflict is resolved. Setting the selection tag 460 equal to 0 indicates the conflict is not resolved. The reverted tag 470 is equal to 1 when the conflicting delta tag 440 is equal to 1 and none of the deltas is chose to replace the baseline file. Setting the selection indication tag 450 to 1 for any of the conflicting delta indicates the user selected that delta instead of any of the other conflicting deltas and the baseline file is changed accordingly.

As described, the invention provides features and advantages such as, but not limited to, a single file that includes contributions from various contributors that are merged into a superset of all changes. The file is portable and contains all information necessary to complete a merge operation. The annotated file is a valid file that is equivalent to its common baseline file having embedded annotations. As such, a model editor can load and edit the annotated file similar to an unannotated file. After creating the annotated file, the common baseline file and contributor files can be closed, significantly reducing memory usage and thus improving system performance. Merge sessions are suspendable at any time by saving the annotated file. This feature enables several users to participate in merging the annotated file. All relevant data is stored within the annotated file, therefore making it possible to reconstruct contributions of the individual contributors.

While the invention has been shown and described with reference to specific preferred embodiments, it should be understood by those skilled in the art that various changes in form and detail may be made therein without departing from the spirit and scope of the invention as defined by the following claims. For example, although described as a method and data file the invention can be embodied as a computer readable medium (e.g., compact disk, DVD, flash memory, and the like) that is sold and distributed in various commercial channels. Also, the computer readable instructions contained on the computer readable medium can be purchased and download across a network (e.g., Internet). Additionally, the invention can be embodied as a computer data signal embodied in a carrier wave for merging changes made to a baseline structured data file. While the invention has been described in terms of structured data (e.g., XML), the methods can be applied to any file format, including Java and C++ source files. In such embodiments, the annotations are stored within multi-line comments and would remain invisible to the compiler, but would be machine readable for merge applications.

1. A method of merging changes made to a baseline structured data file comprising:
beginning a first merge session by accessing an annotated structured data file;
reviewing, by a first user, at least one annotation within the annotated data file;
saving the annotated data file to create an incomplete merge file; and
closing the first merge session in response to the first user indicating the end the first merge session.

2. The method of claim 1 further comprising generating the annotated structured data file prior to beginning the first merge session.

3. The method of claim 2 wherein generating the annotated structured data file comprises:
executing a difference generator on a baseline structured data file, a first contributor structured data file, and a second contributor structured data file to generate a delta table and a conflict table;
copying the baseline structured data file; and
annotating the copy of the baseline structured data file to include each entry of the delta table and the conflict table.

4. The method of claim 1 further comprising transferring the incomplete merge file to the second user over a network.

5. The method of claim 4 further comprising beginning a second merge session by accessing the incomplete merge file and reviewing, by a second user, at least one annotation within the incomplete merge file.

6. A computer readable medium for merging changes made to a baseline structured data file, the computer readable medium comprising instructions to cause a processor to:
begin a first merge session by accessing an annotated structured data file;
provide for a review by a first user of at least one annotation within the annotated data file;
save the annotated data file to create an incomplete merge file; and
close the first merge session in response to the first user indicating the end the first merge session.

7. The computer readable medium of claim 6 further comprising instructions to generate the annotated structured data file prior to beginning the first merge session.

8. The computer readable medium of claim 7 wherein the instructions to generate the annotated structured data file comprises instructions to:
execute a difference generator on a baseline structured data file, a first contributor structured data file, and a second contributor structured data file to generate a delta table and a conflict table;
copy the baseline structured data file; and
annotate the copy of the baseline structured data file to include each entry of the delta table and the conflict table.

9. The computer readable medium of claim 6 further comprising instructions to transfer the incomplete merge file to the second user over a network.

10. The computer readable medium of claim 9 further comprising instructions to begin a second merge session by accessing the incomplete merge file and reviewing, by a second user, at least one annotation within the incomplete merge file.

11. A computer data signal embodied in a carrier wave for merging changes made to a baseline structured data file, the computer data signal comprising:
program code for beginning a first merge session by accessing an annotated structured data file;
program code for reviewing, by a first user, at least one annotation within the annotated data file;
program code for saving the annotated data file to create an incomplete merge file; and
program code for closing the first merge session in response to the first user indicating the end the first merge session.

12. The computer data signal of claim 11 further comprising program code for generating the annotated structured data file prior to beginning the first merge session.

13. The computer data signal of claim 12 wherein the program code for generating the annotated structured data file comprises:
program code for executing a difference generator on a baseline structured data file, a first contributor structured data file, and a second contributor structured data file to generate a delta table and a conflict table;
program code for copying the baseline structured data file; and
program code for annotating the copy of the baseline structured data file to include each entry of the delta table and the conflict table.

14. The computer data signal of claim 11 further comprising program code for transferring the incomplete merge file to the second user over a network.

15. The computer data signal of claim 14 further comprising program code for beginning a second merge session by accessing the incomplete merge file and reviewing, by a second user, at least one annotation within the incomplete merge file.

16. An apparatus for merging changes made to a baseline structured data file, the computer data signal comprising:
means for accessing an annotated structured data file to begin a first merge session;
means for reviewing, by a first user, at least one annotation within the annotated data file;
means for saving the annotated data file to create an incomplete merge file; and
means for closing the first merge session in response to the first user indicating the end the first merge session.

17. The apparatus of claim 16 further comprising means for generating the annotated structured data file prior to beginning the first merge session.

18. The apparatus of claim 17 wherein the means for generating the annotated structured data file comprises:
means for determining differences between a baseline structured data file, a first contributor structured data file, and a second contributor structured data file to generate a delta table and a conflict table;
means for copying the baseline structured data file; and
means for annotating the copy of the baseline structured data file to include each entry of the delta table and the conflict table.

19. The apparatus of claim 16 further comprising means for transferring the incomplete merge file to the second user over a network.

20. The apparatus of claim 19 further comprising means for accessing the incomplete merge file and reviewing at least one annotation within the incomplete merge file, by a second user, to begin a second merge session.

21. A computer readable medium comprising instructions configured to cause a computer to generate a portable annotated data structure comprising a baseline data structure and at least one delta associated with a portion of the baseline data structure.
